(19) United States
(12) Patent Application Publication
(10) Pub. No.: US 2026/0211842 A1
(43) Pub. Date: Jul. 23, 2026

(54) CONVERTING STORAGE VOLUME FORMATS

(71) Applicant: Hewlett Packard Enterprise Development LP, Spring, TX (US)

(72) Inventors: Alban Kit Lyndem, Bangalore (IN); Ashutosh Kumar, Bangalore (IN); Hiro Rameshlal Lalwani, Bangalore (IN); Sri Satya Sudhanva Kambhammettu, Bangalore (IN); Anand Andaneppa Ganjihal, Bangalore (IN); Jayasankar Nallasamy, Bangalore (IN); Rohit Balakrishna, Bangalore (IN)

(21) Appl. No.: 19/058,120

(22) Filed: Feb. 20, 2025

(30) Foreign Application Priority Data
Jan. 20, 2025 (IN) 202541004413

(51) Int. Cl. G06F 16/11; G06F 16/16; G06F 16/188

(52) U.S. Cl. CPC G06F 16/116; G06F 16/164; G06F 16/188

(57) ABSTRACT

In certain implementations, a system includes one or more processors and one or more non-transitory computer-readable storage media storing programming for execution by the one or more processors. The programming includes instructions to shut down one or more virtual machines that are managed by a first hypervisor. The first hypervisor is running on a first host, and the one or more virtual machines are able to read and store data in a first filesystem in a storage volume. The programming includes further instructions to unmount the first filesystem from the first host by removing the first filesystem from an active file hierarchy of the first hypervisor, and to attach the storage volume to a second host on which a second hypervisor is running. The programming includes further instructions to create a second filesystem in the storage volume and mount the storage volume with the second filesystem on the second host.

### BACKGROUND

Filesystems and storage volumes are fundamental components of modern computing environments, playing an important role in data organization, storage, and retrieval. In both personal and enterprise settings, various filesystem types are employed to manage data across a wide range of devices and platforms. A filesystem is a method of organizing and storing files on a storage device, providing a structure for naming, accessing, and managing data. It defines how files are named, stored, and retrieved from the storage device. A storage volume may be a physical or logical partition of a storage device, where the storage volume has a single filesystem. In many computing environments, particularly in virtualized or cloud-based infrastructures, multiple filesystem types and storage volume configurations are used to accommodate diverse application requirements, legacy systems, and emerging technologies.

### BRIEF DESCRIPTION OF THE DRAWINGS

Aspects of the present disclosure are best understood from the following detailed description when read with the accompanying figures.

FIG. 1A illustrates an example system of a filesystem conversion solution that may operate across multiple hypervisor environments, according to some implementations.

FIG. 1B illustrates an example implementation of a computer system that can utilize processes according to some implementations.

FIG. 2A illustrates a process for converting a source filesystem to a target filesystem within a storage volume of a storage device, according to some implementations.

FIG. 2B illustrates a block diagram that shows the states of a storage volume on a storage device during a process for converting a source filesystem to a target filesystem, according to some implementations.

FIG. 3 illustrates an example method for converting a source filesystem to a target filesystem within a storage volume of a storage device, according to some implementations.

FIG. 4 illustrates an example method for converting a source filesystem to a target filesystem within a storage volume of a storage device, according to some implementations.

### DESCRIPTION

With the increasing mobility of data across diverse platforms and cloud environments, efficient conversion of data within an enterprise landscape bears increasing importance. This data conversion may include migrating data from one filesystem format to another target filesystem format. Conversions of filesystems to corresponding target filesystems in a fast and efficient manner, including potentially for the larger volume sizes prevalent in modern enterprise environments, is challenging. For example, a filesystem conversion solution may attempt to address the challenges posed by the substantial time and resource requirements typically associated with data migration.

A solution for converting data from a source filesystem format to a target filesystem format may include using a filesystem conversion application (e.g., a script written in a high-level programming language, such as for example, a PYTHON script). In some implementations, the filesystem conversion application may be configured for use in cloud-based environments. In some implementations, the filesystem conversion application may operate across two primary components: a first host running a first hypervisor (e.g., VMWARE's ELASTIC SKY X INTEGRATED (ESXi)), and a second host (e.g., a LINUX host) running a second hypervisor (e.g., a Kernel-based Virtual Machine (KVM)). The first host and the second host may be connected to a shared storage device that contains the storage volume to be converted. The first hypervisor may manage one or more first virtual machines, while the second hypervisor may manage one or more second virtual machines. The filesystem conversion application may be configured to execute certain steps on each of the first host and the second host. The first hypervisor on the first host allows the first virtual machine to read and store data in the source filesystem format (e.g., Virtual Machine File System (VMFS)) in the storage volume on the shared storage device, while the second hypervisor on the second host allows the second virtual machine to read and store data in the target filesystem format (e.g., fourth extended file system (ext4)) on the storage volume in the same shared storage device after conversion. This configuration allows the filesystem conversion application to interact with both the source and target environments, facilitating the conversion process between the different filesystem formats used by each virtualization platform.

Certain implementations of this disclosure provide techniques for efficiently converting between filesystem formats without copying the actual file data stored in the storage volume, particularly in the context of migrating virtual machines between different hypervisor environments. These techniques may enhance the ability to, for example, transform from a first hypervisor based setup to a second hypervisor based setup. For example, in a first step, the filesystem conversion application may safely shut down the first virtual machines running on the first hypervisor. A graceful shutdown may ensure that the first virtual machines complete their current operations and save their states properly to the source filesystem format (e.g., Virtual Machine File System (VMFS)) before powering off. In a second step, the filesystem conversion application may unmount the source filesystem by removing the storage volume from the first host's active file hierarchy, making it inaccessible to the first host and the first virtual machine. When unmounted, the storage volume may remain intact on the storage device, but the first host can no longer read from or write to it. In a third step, the storage volume may be detached from the first host. After the third step is performed, the first hypervisor may no longer recognize the storage device as part of its available resources. In a fourth step, the previously-detatched storage volume is logically connected to the second host, such as by instructing the second host to recognize and take control of the storage volume. In a fifth step, the filesystem conversion application may execute a customized version of an mkfs (make filesystem) tool. The customized mkfs tool is a utility designed to analyze the existing source filesystem structure and create a new filesystem without altering the original data, as shown in the sixth step to the eleventh step that are described below.

When the mkfs tool is executed, it performs the sixth step that may include performing a comprehensive analysis of the source filesystem structure. The mkfs tool may read the source filesystem superblock to understand the overall filesystem layout. The mkfs tool may then examine the inode table and free block table to map out how the source filesystem allocates and tracks data blocks. In addition, the mkfs tool may analyze the inode table to understand the hierarchy of files and directories. In a seventh step, the mkfs tool may create a detailed mapping of some and possibly all allocated inodes (file entries in the source filesystem) and their corresponding data blocks. The mkfs tool may traverse the source filesystem metadata structures, including the inode table and extent lists, to build a comprehensive map of which data blocks belong to which files. In an eighth step, the mkfs tool may scan the storage volume to find a contiguous free space large enough to accommodate the target filesystem metadata. For example, the mkfs tool may use the source filesystem allocation bitmaps to identify unused areas. The mkfs tool might ensure this free space is sufficiently large to hold the target filesystem superblock, group descriptors, inode table, and block bitmaps without overwriting existing source filesystem data. In a ninth step, the mkfs tool may create the basic target filesystem structure to fit into the identified free space. For example, the mkfs tool may write the target filesystem superblock that may contain information such as, for example, block and inode counts, and block group details. The mkfs tool then may create group descriptors, which divide the target filesystem into manageable sections. In a tenth step, the mkfs tool may populate the core data structures of the newly-created target filesystem. For example, the inode table may be initialized to represent some and possibly all files and directories from the source filesytem file attributes (such as permissions, timestamps, and size) into the target filesystem inode format. The block bitmap may be set up to reflect which data blocks are in use, marking blocks as occupied based on the source filesystem data block mapping created earlier. This may ensure that the target filesystem does not overwrite existing data. The inode bitmap may be initialized to indicate which inodes in the inode table are allocated, corresponding to existing files and directories. In an implementation, the mkfs tool may mark the data blocks of the source filesystem as bad blocks in the target filesystem, rather than marking them as free blocks, to ensure that these blocks are not overwritten subsequently. As a result, an ability to mount the storage volume back as the source filesystem to be accessed and utilized by the first host is preserved.

In an eleventh step, the filesystem conversion application mounts the storage device on the second host to make the newly-converted filesystem (e.g., the target filesystem) accessible to the second host (e.g., the LINUX host). This process may include the second host recognizing the target filesystem structure, reading its superblock, and setting up the necessary data structures in memory to allow file operations. Once mounted, the target filesystem may become accessible to the second host and its applications, potentially allowing read and write operations to the storage volume. In a twelfth step, the filesystem conversion application may execute a virt-v2v-in-place tool to transform the first virtual machines from their original format (e.g., VMWARE virtual machines) to the second virtual machines that each have a format compatible with the second host (e.g., KVM compatible virtual machines). The virt-v2v-in-place tool may operate on the newly mounted target filesystem, which now contains the original data from the source filesystem volume.

Certain implementations of this disclosure may provide one or more technical advantages. For example, certain implementations may reduce the time to migrate data from a first hypervisor environment (e.g., VMware ESXi) to a second hypervisor (e.g., KVM) environment by allowing for a conversion from the source filesystem format to the target file system format within the same storage volume, without having to copy data to a separate storage volume. This conversion process, which may be facilitated by certain implementations of the filesystem conversion application, may reduce the time for large-scale migrations, including in environments with substantial storage capacities. In certain implementations, by performing the conversion from the source filesystem to the target filesystem within the same storage volume and reducing or eliminating data copying, a risk of data corruption or data loss during the conversion process may be reduced. In certain implementations, by utilizing the same storage volume for both the source and target filesystems, use of additional storage space or memory to temporarily hold copied data may be reduced or eliminated, which is particularly beneficial in cloud-based environments where resource efficiency is crucial.

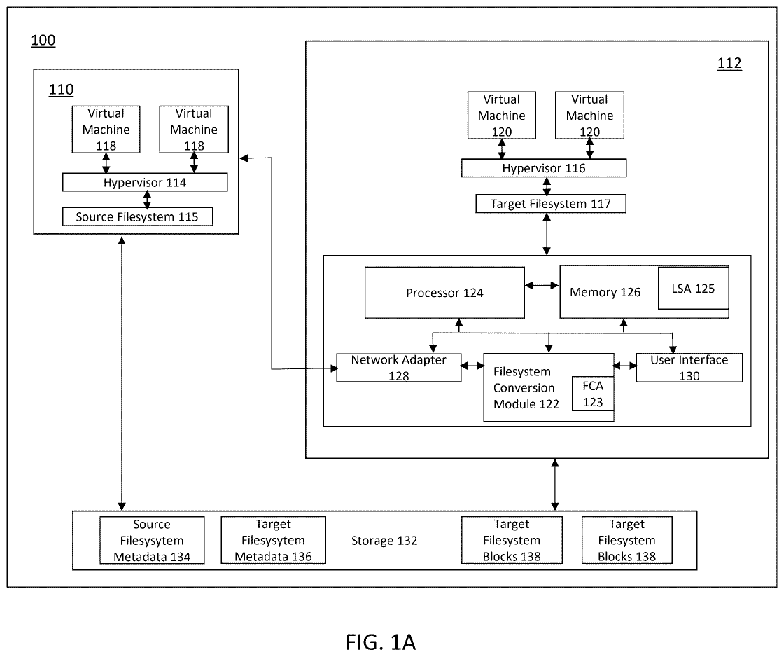

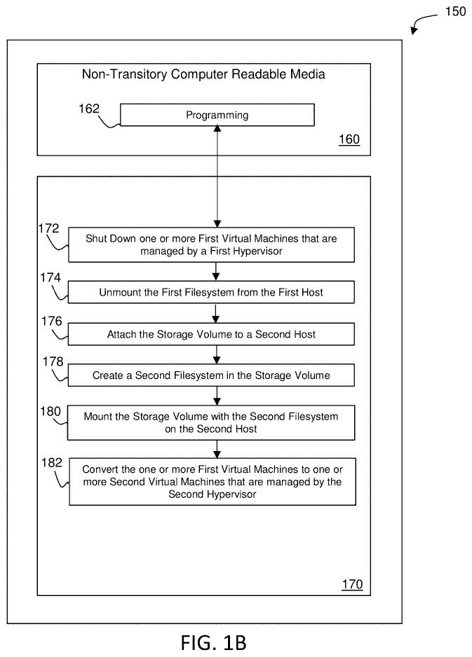

FIG. 1A illustrates an example system 100 of a filesystem conversion solution that may operate across multiple hypervisor environments. In an implementation, the system 100 may be configured for use in a cloud-based environment. In an implementation, the system 100 may facilitate a filesystem conversion process that allows for a conversion of filesystem formats within a storage volume and migration of virtual machines between different hypervisor environments without having to copy the actual file data stored in the storage volume.

The system 100 may include two or more hypervisors. Each hypervisor may be a software layer that manages the hardware resources of the system 100 and enables the creation and operation of multiple virtual machines. For example, the system 100 may include a first host 110 running a first hypervisor 114 (e.g., VMWARE's ESXi), and a second host 112 (e.g., a LINUX system running on a LINUX operating system) running a second hypervisor 116 (e.g., KVM). In an implementation, each hypervisor may manage its respective virtual machines (e.g., first virtual machines 118 for the first hypervisor 114 and second virtual machines 120 for the second hypervisor 116). The first hypervisor 114 and the second hypervisor 116 may represent the source environment and target environment, respectively, for the migration of virtual machines. The first host 110 may access and utilize a source filesystem 115, which represents the filesystem format used by the first hypervisor 114 (e.g., VMWARE's ESXi). In an implementation, the source filesystem 115 may be a Virtual Machine File System (VMFS) datastore, which is specifically designed to store and manage virtual machine files in VMware environments. The source filesystem 115 may reside on a volume in a storage device (e.g., storage 132 described below). In an implementation, the second host 112 may access and utilize a target filesystem 117, which represents the filesystem format compatible with the second hypervisor 116 (e.g., KVM running on a LINUX system). In an implementation, this target filesystem 117 may be a LINUX-compatible filesystem, such as the fourth extended filesystem (ext4). The target filesystem 117 may be reside on the same volume in the storage 132 as the source filesystem 115.

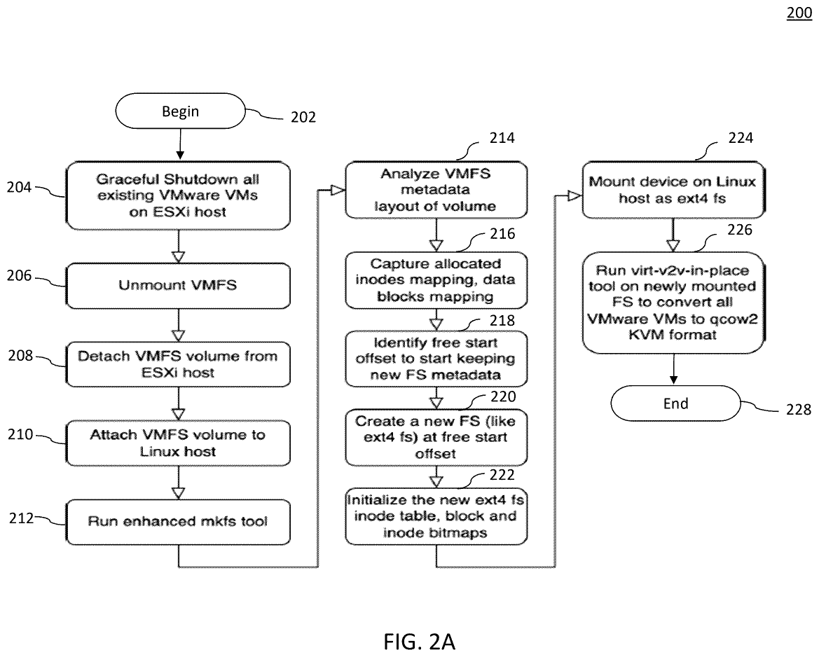

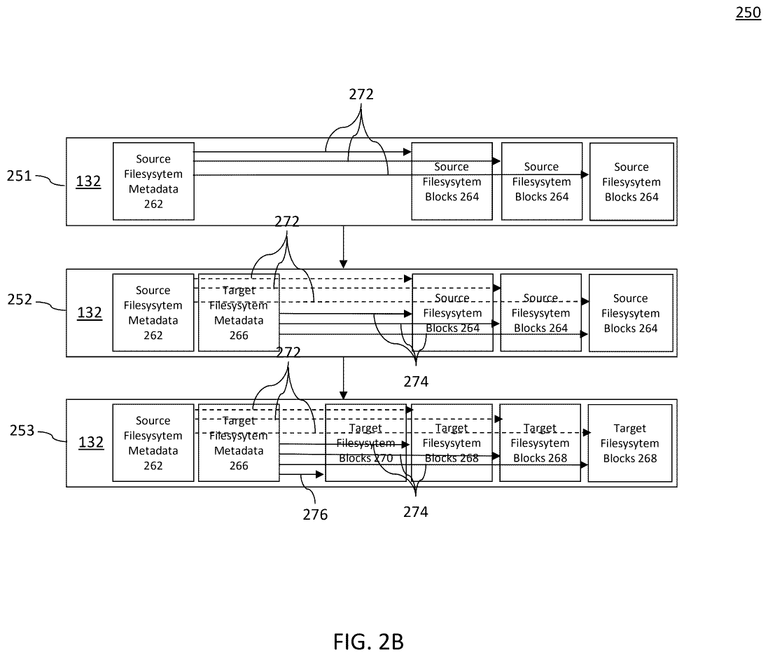

In an implementation, the second host 112 of the system 100 may include a processor 124 that may perform a variety of operations such as executing various algorithms for the filesystem conversion process, executing the filesystem conversion application, executing specialized tools like a customized make filesystem (mkfs) tool and a virt-v2v-in-place tool (described subsequently in FIG. 2A), and processing of data from both the first host 110 and the second host 112. The processor 124 may include one or more programmable logic devices, microprocessors, application-specific integrated circuits (ASICs), controllers, or any other suitable computing devices or resources or any combination of the preceding. In certain implementations, the processor 124 may be or may include a central processing unit (CPU).

In an implementation, the second host 112 of the system 100 may include a memory 126, which may include a non-transitory computer readable medium that stores programming for execution by the processor 124. The memory 126 may provide fast, temporary storage for data and instructions that are actively used by the processor 124. This may include running processes, running the second virtual machines 120, and storing intermediate calculations during the filesystem conversion process. The first host 110 may include its own hardware components (not shown in FIG. 1A) such as a processor and memory that allow it to run the first hypervisor 114 and manage the first virtual machines 118. The second host 112 may include a network adapter 128 that may incorporate an Ethernet adapter, high-speed network interfaces, or other networking technologies that are suitable with for example, cloud-based environments. The network adapter 128 may facilitate communication between the first host 110 and the second host 112 during the filesystem conversion process. The network adapter 128 may support communication with external systems and networks, which may allow for integration with broader cloud services and management platforms. Users may interact with the system 100 through a user interface 130. The user interface 130 may be implemented as a web-based interface, for example, that allows secure access from various devices and locations. The web-based interface may be suitable for the management of cloud-based environments.

The second host 112 of the system 100 may include a filesystem conversion module 122. The filesystem conversion module 122 may be implemented as a software component running on the processor 124. In an implementation, the filesystem conversion module 122 may execute the core functionality of the filesystem conversion solution. Within the filesystem conversion module 122, a filesystem conversion application (FCA) 123 may be executed. The filesystem conversion application 123 may be a specialized program that provides the specific logic and instructions for converting filesystems and migrating virtual machines. In certain implementations, the filesystem conversion application 123 may be a script (e.g., written in a high-level programming language such as PYTHON) that is stored in a logic storage area (LSA) 125 of the memory 126. The filesystem conversion module 122, through the filesystem conversion application 123, may facilitate the automated conversion of filesystems (e.g., from the source filesystem 115 to the target filesystem 117) and migration of virtual machines between different hypervisor environments (e.g., from the first hypervisor 114 running on the first host 110 to the second hypervisor 116 running on the second host 112).

In an implementation, the filesystem conversion application 123 may, for example, analyze the source filesystem 115, create new metadata for the target filesystem 117, and perform the filesystem conversion process without copying file data. The filesystem conversion application 123 may interact with the first hypervisor 114 and the second hypervisor 116 to gather data and run filesystem conversion algorithms. The filesystem conversion application 123 may also manage specialized tools for filesystem creation and virtual machine format conversion.

The system 100 may also include a storage 132, which may be used to store a storage volume containing the source filesystem 115, target filesystem 117, and associated data structures. The storage volume is a logical container that can span one or more physical storage devices and serves as the primary unit for filesystem management. In an implementation, the storage 132 may contain both the original data and the newly created filesystem structures within this storage volume. The storage 132 may be a storage device that includes solid-state drives (SSD), hard disk drives (HDD), or other high-performance storage technologies that are suitable for use in, for example, cloud-based environments. In an implementation, the storage volume within the storage 132 may be used to store source filesystem metadata 134 that may include metadata of the source filesystem 115 (e.g., VMFS), including information about file and directory structures, permissions, and other filesystem-specific attributes. The storage volume may also be used to store target filesystem metadata 136 that includes newly created metadata for the target filesystem 117 (e.g., ext4), which is generated during the filesystem conversion process without altering the original data. Additionally, in an implementation, the storage volume may store target filesystem blocks 138, where each target filesystem block 138 is a fixed-size unit of data. The target filesystem blocks 138 may be created and used by the target filesystem 117 after the filesystem conversion process is complete.

The storage volume within the storage 132 may be accessed by both the first host 110 and the second host 112, allowing for efficient filesystem conversion and virtual machine migration between different hypervisor environments (e.g., between the first hypervisor 114 and the second hypervisor 116). The filesystem conversion module 122 may interact with the storage volume to analyze the source filesystem structure, create new metadata, and manage the filesystem conversion process, all within the same physical storage space.

FIG. 1B depicts an example implementation of a computer system 150 that can utilize processes disclosed herein. The computer system is part of computer system 100 shown in FIG. 1A. For example, the system 150 may be a sub-system of the system 100. Further details of the process are provided in FIG. 2A.

As shown in FIG. 1B, the computer system 150 comprises one or more processors 170 and one or more non-transitory computer-readable storage media 160 storing programming 162 for execution by the one or more processors 170. The programming comprises instructions 172-182 to shut down one or more first virtual machines that are managed by a first hypervisor, the first hypervisor running on a first host, the one or more first virtual machines being able to read and store data in a first filesystem in a storage volume (172). The first filesystem is unmounted from the first host by removing the first filesystem from an active file hierarchy of the first hypervisor (174). The storage volume is attached to a second host, where a second hypervisor is running on the second host (176). A second filesystem is created in the storage volume (178). The storage volume with the second filesystem is mounted on the second host (180). One or more first virtual machines are converted to one or more second virtual machines that are managed by the second hypervisor, the one or more second virtual machines being able to read and store data in the second filesystem in the storage volume (182).

FIG. 2A illustrates a flowchart 200 of a process for converting a source filesystem (e.g., the source filesystem 115) to a target filesystem (e.g., the target filesystem 117) within a storage volume of a storage device (e.g., the storage 132). The filesystem conversion process may allow for a conversion of filesystem formats within the storage volume and migration of virtual machines between different hypervisor environments (e.g., the first hypervisor 114 running on the first host 110 and the second hypervisor 116 running on the second host 112) without having to copy the actual file data stored in the storage volume. The process depicted in FIG. 2A may be performed using the components and architecture described in FIG. 1A, although other architectures could also utilize the process.

Step 202 marks the beginning of the filesystem conversion process. In an implementation, the filesystem conversion process may be initiated by executing the filesystem conversion application 123. The filesystem conversion application 123 may be implemented as a script (e.g., written in a high-level programming language such as Python) and stored in the logic storage area (LSA) 125 of the memory 126. In an implementation, a user may activate the filesystem conversion application 123 through various means, such as by interacting with the user interface 130. The filesystem conversion application 123 may be configured to execute certain steps on each of the first host 110 and the second host 112. For example, steps 204, 206, and 208 of the flowchart 200 may be executed on the first host 110. Steps, 210, 212, 214, 216, 218, 220, 222, 224, and 226 may be executed on the second host 112.

In step 204, the filesystem conversion application 123 may initiate a graceful shutdown of all existing virtual machines (e.g., the first virtual machines 118) running on the first host 110, which is operating the first hypervisor 114 (e.g., VMware's ESXi). In an implementation, the first virtual machines 118 are being managed by the first hypervisor 114. The step 204 may help to maintain data integrity and consistency throughout the filesystem conversion process. The graceful shutdown ensures that all the first virtual machines 118 complete their current operations and save their states properly to the source filesystem 115 (e.g., VMFS) before powering off. This process involves the filesystem conversion application 123 communicating with the first hypervisor 114 to safely terminate all running first virtual machines 118, and allowing guest operating systems to close any applications that are running.

In step 206, the filesystem conversion application 123 may unmount the source filesystem 115 (e.g., VMFS datastore) from the first host 110. The filesystem conversion application 123 may instruct the first hypervisor 114 (e.g., VMware's ESXi) to remove the source filesystem 115 from its active file hierarchy, making it inaccessible to the first host 110 and its first virtual machines 118. When the source filesystem 115 is unmounted, the storage 132 and the storage volume within it may remain recognizable and connected to the first host 110. However, the unmounting process may prevent any further read or write operations to the source filesystem 115. The first hypervisor 114 remains aware of the storage 132 but can no longer access the source filesystem 115.

In step 208, the filesystem conversion application 123 may detach the storage 132 and the storage volume within the storage 132 that contains the source filesystem 115 (e.g., VMFS) from the first host 110. The filesystem conversion application 123 instructs the first hypervisor 114 (e.g., VMware's ESXi) to completely remove the storage volume and the storage 132 from its inventory of available resources. After this step, the first hypervisor 114 no longer recognizes or has any awareness of the storage 132 or the storage volume within the storage 132.

In step 210, the filesystem conversion application 123 may attach the previously detached storage 132 and the storage volume on the storage 132 from the step 208 containing the source filesystem 115 (e.g., VMFS) to the second host 112 (e.g., the LINUX host). This process may involve the filesystem conversion application 123 instructing the second hypervisor 116 (e.g., KVM) running on the second host 112 to recognize and take control of the storage 132 and the storage volume within it. In this way, the filesystem conversion application 123 may instruct the second hypervisor 116 to add the storage 132 to its inventory of available resources.

In step 212, the filesystem conversion application 123 may run a customized version of an mkfs (make filesystem) tool on the second host 112. The customized mkfs tool may be an enhanced utility that analyzes the existing source filesystem 115 structure and creates a new target filesystem 117 in the storage volume of the storage 132 without altering the original data in the storage volume of the storage 132. It performs a series of operations that are described in the subsequent steps 214 to 222, which include analyzing the source filesystem 115 metadata, mapping data blocks, identifying free space for new structures, and creating and initializing the target filesystem 117.

In step 214, the mkfs tool may perform a comprehensive analysis of the source filesystem 115 (e.g., VMFS) metadata layout within the storage volume of the storage 132. This may involve examining the source filesystem 115 structural components in detail. In an implementation, the mkfs tool may start by reading the source filesystem 115 (e.g., VMFS) superblock, which is a data structure that contains information about the filesystem's overall layout, including block size, filesystem size, and version information. The mkfs tool may then examine the source filesystem 115 inode table, which stores metadata about individual files and directories, including their size, permissions, and the location of their data blocks. The mkfs tool also analyzes the block allocation table (BAT) which is a source filesystem 115 specific structure that tracks how data blocks are allocated and linked. Additionally, the mkfs tool may examine the source filesystem 115 inode table to understand the hierarchy of files and directories within the source filesystem 115.

In step 216, the mkfs tool creates a detailed mapping of allocated inodes and their corresponding data blocks in the source filesystem 115 (e.g., VMFS) within the storage volume of the storage 132. The step 216 utilizes the information gathered from the source filesystem 115 superblock, inode table, and block allocation table in the previously described step 214. The mkfs tool builds a comprehensive map of which data blocks belong to which files and directories in the storage volume. This process may involve recording the relationships between inodes (which represent files and directories) and the actual data blocks that contain the file contents. Additionally, the mkfs tool may map both the allocated and free blocks within the storage volume to determine the space utilization within the storage volume. The comprehensive mapping allows the mkfs tool to create a complete representation of the source filesystem 115 structure within the storage volume, including how inodes are organized, where data is stored, which blocks are in use, and which blocks are available for potential use by the target filesystem 117.

In step 218, the mkfs tool may scan the storage volume of the storage 132 to identify a contiguous free space large enough to accommodate the metadata structures of the target filesystem 117 (e.g., ext4). The mkfs tool may utilize the comprehensive mapping created in the previous step 216, particularly the information about free blocks in the storage volume, to locate an appropriate area in the storage volume in which to store the target filesystem 117 metadata without having to overwrite any existing data from the source filesystem 115. In an implementation, the mkfs tool may look for a free start offset, which is a location in the storage volume where it can begin writing the target filesystem 117 metadata structures, such as the superblock, group descriptors, inode table, and block bitmaps.

In step 220, the mkfs tool may create the basic structure of the target filesystem 117 (e.g., ext4) at the free start offset identified previously in the step 218. This process may involve writing the metadata structures for the target filesystem 117. First, the mkfs tool may create and write the superblock of the target filesystem 117, which may contain information such as the filesystem's size, block size, and inode count. Following the creation of the target filesystem 117 superblock, the mkfs tool may write the group descriptors, which divide the target filesystem 117 into manageable sections called block groups. The group descriptors may contain information about the layout of each block group, including the locations of the block bitmap, inode bitmap, and inode table within each group. The mkfs tool may carefully calculate and set up these structures to fit within the identified free space in the storage volume, ensuring they don't overwrite any existing data from the source filesystem 115. In an implementation, a block size of the target filesystem 117 (e.g., ext4) may be set up by the mkfs tool to be equal to a block size of the source filesystem 115 (e.g., VMFS). For example, if the source filesystem 115 is a VMFS version 5 or 6, which may use a block size of 1 MB, the target filesystem 117 (e.g., ext4) may also be created having a block size of 1 MB.

In the step 222, the mkfs tool may initialize metadata structures of the newly-created target filesystem 117 (e.g., ext4). This may involve creating and populating a new inode table, block bitmap, and inode bitmap for the target filesystem 117. The new inode table for the target filesystem 117 may be initialized to represent all files and directories from the source filesystem 115, translating their attributes (such as permissions, timestamps, and size) into the target filesystem 117 inode format. The new inode table may be distinct from the source filesystem 115 inode table and may be structured according to the target filesystem 117 requirements. The block bitmap may be set up to reflect which data blocks are in use, marking blocks as occupied based on the source filesystem 115 data block mapping created previously in step 216. This ensures that the target filesystem 117 does not overwrite any already existing data in the storage volume. The inode bitmap is initialized to indicate which inodes in the new inode table are allocated, corresponding to existing files and directories. In an implementation, to preserve the ability to mount the storage volume back as the source filesystem 115 (e.g., VMFS) to be accessed and utilized by the first host 110, the mkfs tool may mark the blocks used by the source filesystem 115 metadata as bad blocks in the target filesystem 117, rather than marking them as free blocks, to ensure that these blocks are not overwritten.

In step 224, the filesystem conversion application 123 may mount the storage 132 on the second host 112 (e.g., the LINUX host) to make the target filesystem 117 accessible to the second host 112. This process may involve the filesystem conversion application 123 instructing the second hypervisor 116 to recognize the target filesystem 117 structure, read its superblock, and set up the data structures in memory to allow file operations. The mounting may be performed by specifying a device offset where the target filesystem 117 metadata (including the superblock, inode table, etc.) is located within the storage volume of the storage 132. The device offset may refer to the starting point within the storage volume of the storage 132 where the target filesystem 117 metadata was created, allowing the second host 112 to bypass the original source filesystem 115 metadata and directly access the target filesystem 117 metadata. Once the storage 132 is mounted on the second host 112, the target filesystem 117 becomes accessible to the second host 112 and its applications, potentially allowing read and write operations to the storage volume of the storage 132.

In step 226, the filesystem conversion application 123 may execute a virt-v2v-in-place tool on the second host 112 to convert the first virtual machines 118 from their original format (e.g., VMware virtual machines) to the second virtual machines 120 that are compatible with the second hypervisor 116 (e.g., KVM-compatible virtual machines). The virt-v2v-in-place tool may operate directly on the target filesystem 117, which is now mounted on the second host 112 and contains the original data from the source filesystem 115. The virt-v2v-in-place tool may convert virtual machine disk images and configuration files from a first format (e.g., the VMware format) to a second format (e.g., the qcow2 (QEMU Copy-On-Write version 2) format) that is compatible with KVM). After the first virtual machines 118 are converted to the second virtual machines 120 that are compatible with the second hypervisor 116 (e.g., KVM-compatible virtual machines), the second virtual machines 120 can be managed and operated by the second hypervisor 116 on the second host 112, utilizing the same underlying data in the storage volume of the storage 132 that was originally used by the first virtual machines 118 on the first host 110. After the virt-v2v-in-place tool completes the conversion of the first virtual machines 118 to the second virtual machines 120, the filesystem conversion process is complete as marked by step 228 of the flowchart 200.

FIG. 2B illustrates a block diagram 250 that shows the states of a storage volume on a storage device (e.g., the storage 132) during the filesystem conversion process described previously in FIG. 2A. The block diagram 250 may show three states (e.g., state 251, state 252, and state 253) of the storage volume, where each state describes the configuration of the storage volume at a corresponding stage of the filesystem conversion process.

State 251 may represent a configuration of the storage volume after the steps 204 to 210 that were described previously in FIG. 2A are performed. In this state, the storage volume may contain source filesystem metadata 262 and source filesystem blocks 264 of the source filesystem 115 (described previously in FIGS. 1-2A). The source filesystem metadata 262 may include structures such as the superblock, inode tables, and block allocation table of the source filesystem 115 (e.g., VMFS). The source filesystem blocks 264 may contain the actual data of files and directories. Arrows 272 from the source filesystem metadata 262 may point to the source filesystem blocks 264, indicating that the source filesystem metadata 262 references and manages these data blocks.

State 252 may illustrate the configuration of the storage volume after the steps 214 to 222 that were described previously in FIG. 2A are performed. In this state, target filesystem metadata 266 may have been created alongside the existing source filesystem metadata 262 and source filesystem blocks 264. The target filesystem metadata 266 may represent the newly created structures for the target filesystem 117 (e.g., ext4), including its superblock and group descriptors. Arrows 272 from the source filesystem metadata 262 may point to the source filesystem blocks 264, indicating that the source filesystem metadata 262 may still be referencing these data blocks. In addition, arrows 274 from the target filesystem metadata 266 may point to the source filesystem blocks 264, indicating that the target filesystem metadata 266 also references these data blocks. The state 252 may reflect the creation of the target filesystem 117 structure without altering the original data in the storage volume of the storage 132. In an implementation, in the state 252, the blocks used by the source filesystem 115 metadata may be marked as bad blocks in the target filesystem 117, rather than marked as free blocks, to ensure that these blocks are not overwritten. As a result, an ability to mount the storage volume back as the source filesystem 115 (e.g., VMFS) to be accessed and utilized by the first host 110 is preserved.

State 253 may depict the final configuration of the storage volume after the steps 224 to 226 that were described previously in FIG. 2A are performed. The state 253 may comprise source filesystem metadata 262, fully initialized target filesystem metadata 266, target filesystem blocks 268 (e.g., which are converted from the source filesystem blocks 264 that were shown in the previous state 252), and target filesystem blocks 270 (e.g., which are newly allocated data blocks that are compatible with the target filesystem 117 (e.g., ext4)). The target filesystem metadata 266 may now include complete inode tables and block bitmaps for the target filesystem 117. Arrows 272 from the source filesystem metadata 262 may point to the target filesystem blocks 268 (e.g., the converted source filesystem blocks 264 shown in the previous state 252), indicating that the source filesystem metadata 262 may still be referencing these data blocks. In addition, arrows 274 from the target filesystem metadata 266 may also point to the target filesystem blocks 268, indicating that the target filesystem metadata 266 manages and references these data blocks. Further, arrows 276 from the target filesystem metadata 266 may point to the target filesystem blocks 270, indicating that the target filesystem metadata 266 manages and references these data blocks. The source filesystem metadata 262 may still be present, potentially allowing for reverting to the source filesystem 115 (e.g., VMFS), if necessary. The state 253 may represent the storage volume ready use with the new target filesystem 117, where the second virtual machines 120 are able to access the data in the storage volume using the target filesystem 117 (e.g., ext4) format, while still utilizing the same data that was originally used by the first virtual machines 118 on the first host 110. In an implementation, at this stage, both read and write operations are now possible on the target filesystem 117.

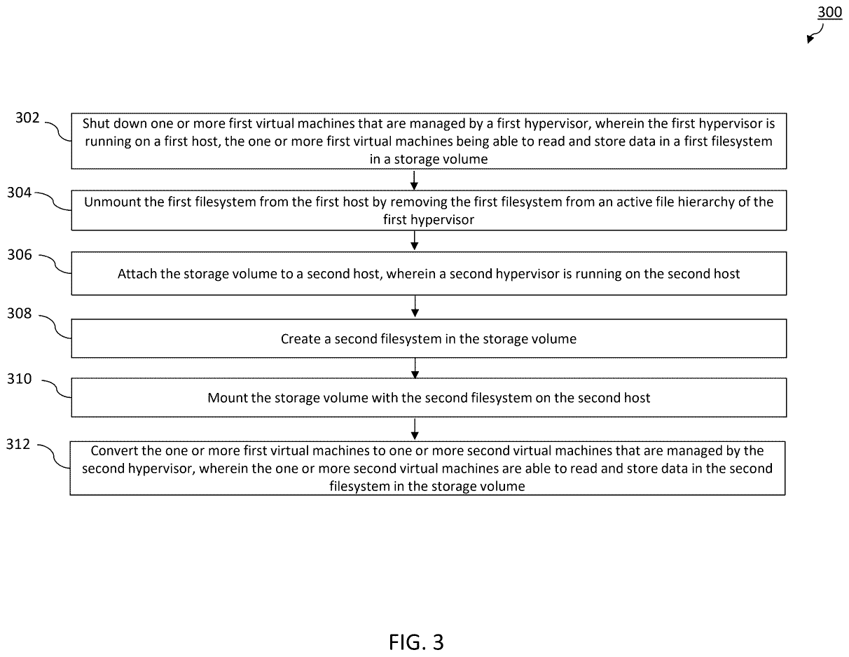

FIG. 3 illustrates an example method 300 for converting a source filesystem (e.g., the source filesystem 115 described previously in FIGS. 1A-2B) to a target filesystem (e.g., the target filesystem 117 described previously in FIGS. 1A-2B) within a storage volume of a storage device (e.g., the storage 132 described previously in FIGS. 1A-2B). In an implementation, the filesystem conversion process may be initiated by executing the filesystem conversion application 123 (described previously in FIGS. 1A-2B). The filesystem conversion application 123 may be configured to execute certain steps on each of the first host 110 (described previously in FIGS. 1A-2B) and the second host 112 (described previously in FIGS. 1A-2B).

In step 302, one or more first virtual machines that are managed by a first hypervisor are shut down, where the first hypervisor is running on a first host, the one or more first virtual machines being able to read and store data in a first filesystem in a storage volume. For example, as described in the step 204 of the flowchart 200, the filesystem conversion application 123 (described previously in FIGS. 1A-2B) may initiate a graceful shutdown of all existing virtual machines (e.g., the first virtual machines 118 described previously in FIGS. 1A-2B) running on the first host 110, which is operating the first hypervisor 114 (e.g., VMware's ESXi). The graceful shutdown ensures that all the first virtual machines 118 complete their current operations and save their states properly to the source filesystem 115 (e.g., VMFS) before powering off.

In step 304, the first filesystem is unmounted from the first host by removing the first filesystem from an active file hierarchy of the first hypervisor. For example, as described in the step 206 of the flowchart 200, the filesystem conversion application 123 (described previously in FIGS. 1A-2B) may unmount the source filesystem 115 (e.g., VMFS datastore) from the first host 110. The filesystem conversion application 123 may instruct the first hypervisor 114 (e.g., VMware's ESXi) to remove the source filesystem 115 from its active file hierarchy, making it inaccessible to the first host 110 and its first virtual machines 118.

In step 306, the storage volume is attached to a second host, where a second hypervisor is running on the second host. For example, as described in the step 210 of the flowchart 200, the filesystem conversion application 123 may attach the previously detached storage 132 and the storage volume on the storage 132 from the step 208 containing the source filesystem 115 (e.g., VMFS) to the second host 112 (e.g., the LINUX host). This process may involve the filesystem conversion application 123 instructing the second hypervisor 116 (e.g., KVM) running on the second host 112 to recognize and take control of the storage 132 and the storage volume within it.

In step 308, a second filesystem is created in the storage volume. For example, as described in the step 212 of the flowchart 200, the filesystem conversion application 123 may run a customized version of the mkfs (make filesystem) tool on the second host 112. The customized mkfs tool may be an enhanced utility that analyzes the existing source filesystem 115 structure and creates a new target filesystem 117 in the storage volume of the storage 132 without altering the original data in the storage volume of the storage 132. First, as described in the step 214 of the flowchart 200, the mkfs tool may perform a comprehensive analysis of the source filesystem 115 (e.g., VMFS) metadata layout within the storage volume of the storage 132. This may involve examining the source filesystem 115 structural components in detail. In an implementation, the mkfs tool may start by reading the source filesystem 115 (e.g., VMFS) superblock, which is a data structure that contains information about the filesystem's overall layout, including block size, filesystem size, and version information. The mkfs tool may then examine the source filesystem 115 inode table, which stores metadata about individual files and directories, including their size, permissions, and the location of their data blocks. The mkfs tool also analyzes the block allocation table (BAT) which is a source filesystem 115 specific structure that track how data blocks are allocated and linked. Additionally, the mkfs tool may examine the source filesystem 115 inode table to understand the hierarchy of files and directories within the source filesystem 115.

The mkfs tool may then create a detailed mapping of allocated inodes and their corresponding data blocks in the source filesystem 115 (e.g., VMFS) within the storage volume of the storage 132, as described in the step 216 of the flowchart 200. The step 216 utilizes the information gathered from the source filesystem 115 superblock, inode table, and block allocation table in the previously described step 214. The mkfs tool builds a comprehensive map of which data blocks belong to which files and directories in the storage volume. This process may involve recording the relationships between inodes (which represent files and directories) and the actual data blocks that contain the file contents. Additionally, the mkfs tool may map both the allocated and free blocks within the storage volume to determine the space utilization within the storage volume. The mkfs tool may then scan the storage volume of the storage 132 as described in the step 218 of the flowchart 200 to identify a contiguous free space large enough to accommodate the metadata structures of the target filesystem 117 (e.g., ext4). The mkfs tool may utilize the comprehensive mapping created in the previous step 216, particularly the information about free blocks in the storage volume, to locate an appropriate area in the storage volume in which to store the target filesystem 117 metadata without having to overwrite any existing data from the source filesystem 115.

The mkfs tool may then create the basic structure of the target filesystem 117 (e.g., ext4) at a free start offset identified previously in the step 218, as described in the step 220 of the flowchart 200. This process may involve writing the metadata structures for the target filesystem 117. First, the mkfs tool may create and write the superblock of the target filesystem 117, which may contain information such as the filesystem's size, block size, and inode count. Following the creation of the target filesystem 117 superblock, the mkfs tool may write the group descriptors, which divide the target filesystem 117 into manageable sections called block groups. Then, the mkfs tool may initialize metadata structures of the newly-created target filesystem 117 (e.g., ext4) as described in the step 222 of the flowchart 200. This may involve creating and populating a new inode table, block bitmap, and inode bitmap for the target filesystem 117. The new inode table for the target filesystem 117 may be initialized to represent all files and directories from the source filesystem 115, translating their attributes (such as permissions, timestamps, and size) into the target filesystem 117 inode format. The new inode table may be distinct from the source filesystem 115 inode table and may be structured according to the target filesystem 117 requirements. The block bitmap may be set up to reflect which data blocks are in use, marking blocks as occupied based on the source filesystem 115 data block mapping created previously in the step 216 of the flowchart 200. This ensures that the target filesystem 117 does not overwrite any already existing data in the storage volume. In an implementation, to preserve the ability to mount the storage volume back as the source filesystem 115 (e.g., VMFS) to be accessed and utilized by the first host 110, the mkfs tool may mark the blocks used by the source filesystem 115 metadata as bad blocks in the target filesystem 117, rather than marking them as free blocks, to ensure that these blocks are not overwritten.

In step 310, the storage volume with the second filesystem is mounted on the second host. For example, as described in the step 224 of the flowchart 200, the filesystem conversion application 123 may mount the storage 132 on the second host 112 (e.g., the LINUX host) to make the target filesystem 117 accessible to the second host 112. This process may involve the filesystem conversion application 123 instructing the second hypervisor 116 to recognize the target filesystem 117 structure, read its superblock, and set up the data structures in memory to allow file operations. Once the storage 132 is mounted on the second host 112, the target filesystem 117 becomes accessible to the second host 112 and its applications, potentially allowing read and write operations to the storage volume of the storage 132.

In step 312, the one or more first virtual machines are converted to one or more second virtual machines that are managed by the second hypervisor, wherein the one or more second virtual machines are able to read and store data in the second filesystem in the storage volume. For example, as described in the step 226 of the flowchart 200, the filesystem conversion application 123 may execute a virt-v2v-in-place tool on the second host 112 to convert the first virtual machines 118 from their original format (e.g., VMware virtual machines) to the second virtual machines 120 that are compatible with the second hypervisor 116 (e.g., KVM-compatible virtual machines). The virt-v2v-in-place tool may operate directly on the target filesystem 117, which is now mounted on the second host 112 and contains the original data from the source filesystem 115. The virt-v2v-in-place tool may convert virtual machine disk images and configuration files from a first format (e.g., the VMware format) to a second format (e.g., the qcow2 (QEMU Copy-On-Write version 2) format) that is compatible with KVM).

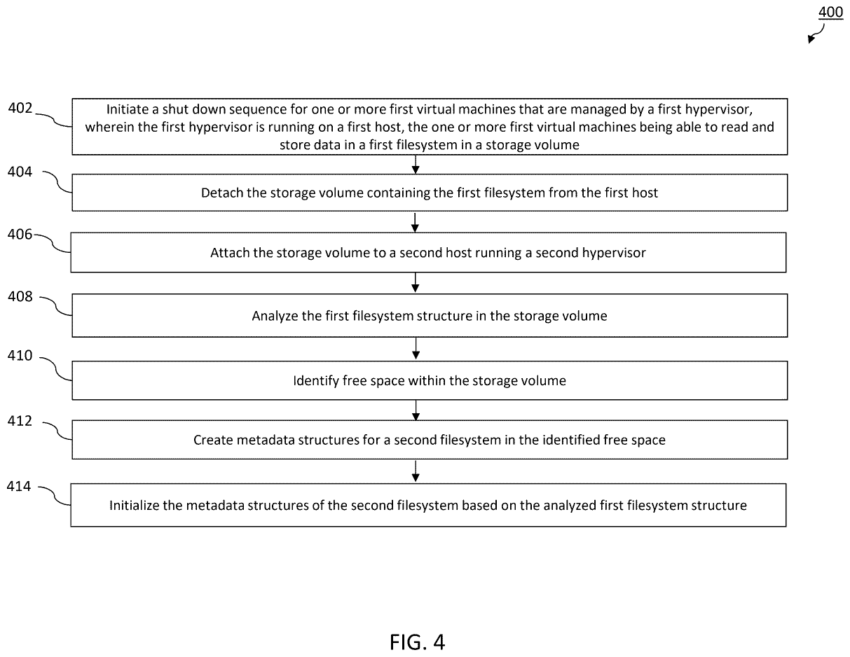

FIG. 4 illustrates an example method 400 for converting a source filesystem (e.g., the source filesystem 115 described previously in FIGS. 1A-2B) to a target filesystem (e.g., the target filesystem 117 described previously in FIGS. 1A-2B) within a storage volume of a storage device (e.g., the storage 132 described previously in FIGS. 1A-2B). In an implementation, the filesystem conversion process may be initiated by executing the filesystem conversion application 123 (described previously in FIGS. 1A-2B).

In step 402, a shut-down sequence for one or more first virtual machines that are managed by a first hypervisor is initiated, where the first hypervisor is running on a first host, the one or more first virtual machines being able to read and store data in a first filesystem in a storage volume. For example, as described in the step 204 of the flowchart 200, the filesystem conversion application 123 (described previously in FIGS. 1A-2B) may initiate a graceful shutdown of all existing virtual machines (e.g., the first virtual machines 118 described previously in FIGS. 1A-2B) running on the first host 110, which is operating the first hypervisor 114 (e.g., VMware's ESXi). The graceful shutdown ensures that all the first virtual machines 118 complete their current operations and save their states properly to the source filesystem 115 (e.g., VMFS) before powering off.

In step 404, the storage volume containing the first filesystem is detached from the first host. For example, as described in step 208 of the flowchart 200, the filesystem conversion application 123 may detach the storage 132 and the storage volume within the storage 132 that contains the source filesystem 115 (e.g., VMFS) from the first host 110. The filesystem conversion application 123 instructs the first hypervisor 114 (e.g., VMware's ESXi) to completely remove the storage volume and the storage 132 from its inventory of available resources. After this step, the first hypervisor 114 no longer recognizes or has any awareness of the storage 132 or the storage volume within the storage 132.

In step 406, the storage volume is attached to a second host running a second hypervisor. For example, as described in the step 210 of the flowchart 200, the filesystem conversion application 123 may attach the previously detached storage 132 and the storage volume on the storage 132 from the step 208 containing the source filesystem 115 (e.g., VMFS) to the second host 112 (e.g., the LINUX host). This process may involve the filesystem conversion application 123 instructing the second hypervisor 116 (e.g., KVM) running on the second host 112 to recognize and take control of the storage 132 and the storage volume within it.

In step 408, the first filesystem structure in the storage volume is analyzed. For example, as described in the step 214 of the flowchart 200, the mkfs tool may perform a comprehensive analysis of the source filesystem 115 (e.g., VMFS) metadata layout within the storage volume of the storage 132. This may involve examining the source filesystem 115 structural components in detail. In an implementation, the mkfs tool may start by reading the source filesystem 115 (e.g., VMFS) superblock, which is a data structure that contains information about the filesystem's overall layout, including block size, filesystem size, and version information. The mkfs tool may then examine the source filesystem 115 inode table, which stores metadata about individual files and directories, including their size, permissions, and the location of their data blocks. The mkfs tool also analyzes the block allocation table (BAT), which is a source filesystem 115 specific structure that tracks how data blocks are allocated and linked. Additionally, the mkfs tool may examine the source filesystem 115 file inode table to understand the hierarchy of files and directories within the source filesystem 115.

In step 410, free space within the storage volume is identified. For example, the mkfs tool may scan the storage volume of the storage 132 as described in the step 218 of the flowchart 200 to identify a contiguous free space large enough to accommodate the metadata structures of the target filesystem 117 (e.g., ext4). The mkfs tool may utilize the comprehensive mapping created in the previous step 216, particularly the information about free blocks in the storage volume, to locate an appropriate area in the storage volume in which to store the target filesystem 117 metadata without having to overwrite any existing data from the source filesystem 115.

In step 412, metadata structures for a second filesystem are created in the identified free space. For example, the mkfs tool may create the basic structure of the target filesystem 117 (e.g., ext4) at a free start offset identified previously in the step 218, as described in the step 220 of the flowchart 200. This process may involve writing the metadata structures for the target filesystem 117. First, the mkfs tool may create and write the superblock of the target filesystem 117, which may contain information such as the filesystem's size, block size, and inode count. Following the creation of the target filesystem 117 superblock, the mkfs tool may write the group descriptors, which divide the target filesystem 117 into manageable sections called block groups.

In step 414, the metadata structures of the second filesystem are initialized based on the analyzed first filesystem structure. For example, the mkfs tool may initialize metadata structures of the newly-created target filesystem 117 (e.g., ext4) as described in the step 222 of the flowchart 200. This may involve creating and populating a new inode table, block bitmap, and inode bitmap for the target filesystem 117. The new inode table for the target filesystem 117 may be initialized to represent all files and directories from the source filesystem 115, translating their attributes (such as permissions, timestamps, and size) into the target filesystem 117 inode format. The new inode table may be distinct from the source filesystem 115 inode table and may be structured according to the target filesystem 117 requirements. The block bitmap may be set up to reflect which data blocks are in use, marking blocks as occupied based on the source filesystem 115 data block mapping created previously in the step 216 of the flowchart 200. This ensures that the target filesystem 117 does not overwrite any already existing data in the storage volume. In an implementation, to preserve the ability to mount the storage volume back as the source filesystem 115 (e.g., VMFS) to be accessed and utilized by the first host 110, the mkfs tool may mark the blocks used by the source filesystem 115 metadata as bad blocks in the target filesystem 117, rather than marking them as free blocks, to ensure that these blocks are not overwritten

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

1. A system, comprising:
one or more processors; and
one or more non-transitory computer-readable storage media storing programming for execution by the one or more processors, the programming comprising instructions to:
shut down one or more first virtual machines that are managed by a first hypervisor, wherein the first hypervisor is running on a first host, the one or more first virtual machines being able to read and store data in a first filesystem in a storage volume, the first filesystem having a first filesystem format;
unmount the first filesystem from the first host by removing the first filesystem from an active file hierarchy of the first hypervisor;
attach the storage volume to a second host, wherein a second hypervisor is running on the second host;
create a second filesystem in the storage volume, the second filesystem having a second filesystem format that is different than the first filesystem format, thereby facilitating conversion of the storage volume from the first filesystem to the second filesystem;
mount the storage volume with the second filesystem on the second host; and
convert the one or more first virtual machines to one or more second virtual machines that are managed by the second hypervisor, wherein the one or more second virtual machines are able to read and store data in the second filesystem in the storage volume.

2. The system of claim 1, wherein the programming comprises further instructions to:
after unmounting the first filesystem from the first host, detach the storage volume from the first host.

3. The system of claim 1, wherein creating the second filesystem in the storage volume comprises:
analyzing a structure of the first filesystem in the storage volume; and
mapping the first filesystem to obtain a representation of free blocks and allocated blocks within the storage volume.

4. The system of claim 3, wherein creating the second filesystem in the storage volume further comprises:
identifying free space in the storage volume; and
creating metadata structures for the second filesystem in the identified free space.

5. The system of claim 4, wherein the programming comprises further instructions to:
initialize the metadata structures of the second filesystem based on the analyzed structure of the first filesystem.

6. The system of claim 1, wherein the second host is configured to operate on a LINUX operating system, and wherein the second filesystem is a LINUX-compatible filesystem.

7. The system of claim 1, wherein the first filesystem is a Virtual Machine File System (VMFS) and the second filesystem is a fourth extended file system (ext4).

8. A computer-implemented method, comprising:
shutting down one or more first virtual machines that are managed by a first hypervisor, wherein the first hypervisor is running on a first host, the one or more first virtual machines being able to read and store data in a first filesystem in a storage volume, the first filesystem having a first filesystem format;
unmounting the first filesystem from the first host by removing the first filesystem from an active file hierarchy of the first hypervisor;
attaching the storage volume to a second host, wherein a second hypervisor is running on the second host;
creating a second filesystem in the storage volume, the second filesystem having a second filesystem format that is different than the first filesystem format, thereby facilitating conversion of the storage volume from the first filesystem to the second filesystem;
mounting the storage volume with the second filesystem on the second host; and
converting the one or more first virtual machines to one or more second virtual machines that are managed by the second hypervisor, wherein the one or more second virtual machines are able to read and store data in the second filesystem in the storage volume.

9. The computer-implemented method of claim 8, wherein creating the second filesystem in the storage volume comprises:
analyzing a structure of the first filesystem in the storage volume;
identifying free space in the storage volume; and
creating metadata structures for the second filesystem in the identified free space.

10. The computer-implemented method of claim 9, wherein creating the second filesystem in the storage volume further comprises:
initializing the metadata structures of the second filesystem based on the analyzed structure of the first filesystem.

11. The computer-implemented method of claim 10, wherein creating the second filesystem in the storage volume further comprises:
mapping the first filesystem to obtain a representation of free blocks and allocated blocks within the storage volume.

12. The computer-implemented method of claim 8, wherein the second host is operating on a LINUX operating system, and wherein the second filesystem is a LINUX-compatible filesystem.

13. The computer-implemented method of claim 8, further comprising:
after unmounting the first filesystem from the first host, detaching the storage volume from the first host.

14. The computer-implemented method of claim 8, wherein the first filesystem is a Virtual Machine File System (VMFS) and the second filesystem is a fourth extended file system (ext4).

15. A computer-implemented method, comprising:
initiating a shut-down sequence for one or more first virtual machines that are managed by a first hypervisor, wherein the first hypervisor is running on a first host, the one or more first virtual machines being able to read and store data in a first filesystem in a storage volume;
detaching the storage volume containing the first filesystem from the first host;
attaching the storage volume to a second host running a second hypervisor;
analyzing a structure of the first filesystem in the storage volume;
identifying free space within the storage volume;
creating metadata structures for a second filesystem in the identified free space; and
initializing the metadata structures of the second filesystem based on the analyzed structure of the first filesystem.

16. The computer-implemented method of claim 15, further comprising:
before detaching the storage volume containing the first filesystem from the first host, unmounting the first filesystem from the first host by removing the first filesystem from an active file hierarchy of the first hypervisor.

17. The computer-implemented method of claim 15, further comprising:
mounting the storage volume with the initialized metadata structures of the second filesystem on the second host.

18. The computer-implemented method of claim 15, further comprising:
mapping the first filesystem to obtain a representation of free blocks and allocated blocks within the storage volume.

19. The computer-implemented method of claim 15, further comprising:
converting the one or more first virtual machines to one or more second virtual machines that are managed by the second hypervisor.

20. The computer-implemented method of claim 15, wherein the first filesystem is a Virtual Machine File System (VMFS) and the second filesystem is a fourth extended file system (ext4).
